(19) United States
(12) Patent Application Publication
(10) Pub. No.: US 2025/0357671 A1
(43) Pub. Date: Nov. 20, 2025

(54) ANTENNA AND WEARABLE DEVICE

(71) Applicant: NEXTPERT INC., New Taipei (TW)

(72) Inventors: CHENG-AN CHEN, New Taipei (TW); JIN-BO CHEN, New Taipei (TW); CHANG-HSIN OU, New Taipei (TW)

(21) Appl. No.: 19/210,086

(22) Filed: May 16, 2025

(30) Foreign Application Priority Data
May 17, 2024 (TW) 113118490

(51) Int. Cl. H01Q 9/04; H01Q 1/22; H01Q 1/24

(52) U.S. Cl. CPC H01Q 9/045; H01Q 1/2291; H01Q 1/241

(57) ABSTRACT

An antenna and a wearable device are provided, the wearable device includes a metal ring, the antenna includes a first feeding portion, a second feeding portion, a third feeding portion, a first radiating portion formed by a portion of the metal ring and connected to the first feeding portion to receive a current fed by the first feeding portion to excite a first frequency band; a second radiating portion staggered with the first radiating portion and connected to the second feeding portion to receive a current fed by the second feeding portion to excite a second frequency band; a third radiating portion staggered with the first radiating portion and the second radiating portion and connected to the third feeding portion to receive a current fed by the third feeding portion to excite a third frequency band; and a grounding portion providing grounding to the metal ring.

### CROSS-REFERENCE TO RELATED APPLICATIONS

This application claims priority to Taiwan Patent Application No. 113118490 filed on May 17, 2024, in Taiwan Intellectual Property Office, the contents of which are incorporated by reference herein.

### FIELD

The subject matter herein generally relates to antenna technology field, and more particularly to an antenna and a wearable device.

### BACKGROUND

With the development of communication technology, smart wearable devices, such as watches or wristbands, also have communication functions. However, in the related art, due to the space limitation in the smart wearable device, the bandwidth and gain of the antenna in the smart wearable device are limited. Based on this, how to set up an antenna with good performance in the limited space of a smart wearable device has become a problem that needs to be solved urgently.

### BRIEF DESCRIPTION OF THE DRAWINGS

Implementations of the present disclosure will now be described, by way of embodiments, with reference to the attached figures.

FIG. 1 is a partial structural exploded view of a wearable device provided in an embodiment of the present application.

FIG. 2 is a schematic diagram of a first viewing angle of a first radiating portion of an antenna provided in an embodiment of the present application.

FIG. 3 is a schematic diagram of a second viewing angle of a first radiating portion of the antenna provided in an embodiment of the present application.

FIG. 4 is a schematic diagram of a second radiating portion and a third radiating portion according to an embodiment of the present application.

FIG. 5 is a schematic diagram of the first radiating portion, the second radiating portion, and the third radiating portion according to an embodiment of the present application.

FIG. 6 is a side view of the wearable device provided in an embodiment of the present application.

FIG. 7 is a schematic diagram of a first matching circuit provided in an embodiment of the present application.

FIG. 8 is a schematic diagram of a first tuning circuit provided in an embodiment of the present application.

FIG. 9 is a schematic diagram of a second tuning circuit provided in an embodiment of the present application.

FIG. 10 is a schematic diagram of a second matching circuit provided in an embodiment of the present application.

FIG. 11 is a schematic diagram of a third tuning circuit provided in an embodiment of the present application.

FIG. 12 is a schematic diagram of a third matching circuit provided in an embodiment of the present application.

FIG. 13 is a graph diagram of an S parameter (scattering parameter) of the first radiating portion according to an embodiment of the present application.

FIG. 14 is a graph diagram of an S parameter (scattering parameter) of the second radiating portion according to an embodiment of the present application.

FIG. 15 is a graph diagram of an S parameter (scattering parameter) of the third radiating portion according to an embodiment of the present application.

FIG. 16 is a graph diagram of an S parameters (scattering parameters) of the first radiating portion operating in a Low Band (LB), Middle Band (MB) and High Band (HB) of LTE and the second radiating portion operating in a GPS frequency band, provided in an embodiment of the present application.

FIG. 17 is a schematic diagram of a wearable device in the prior art.

FIG. 18 is a schematic diagram of another wearable device in the prior art.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

With the development of communication technology, smart wearable devices, such as watches or wristbands, also have communication functions. However, in the related art, due to the space limitation in the smart wearable device, the bandwidth and gain of the antenna in the smart wearable device are limited. Based on this, how to set up an antenna with good performance in the limited space of a smart wearable device has become a problem that needs to be solved urgently.

Based on this, the present application provides an antenna and a wearable device having a wider bandwidth and good antenna gain and efficiency.

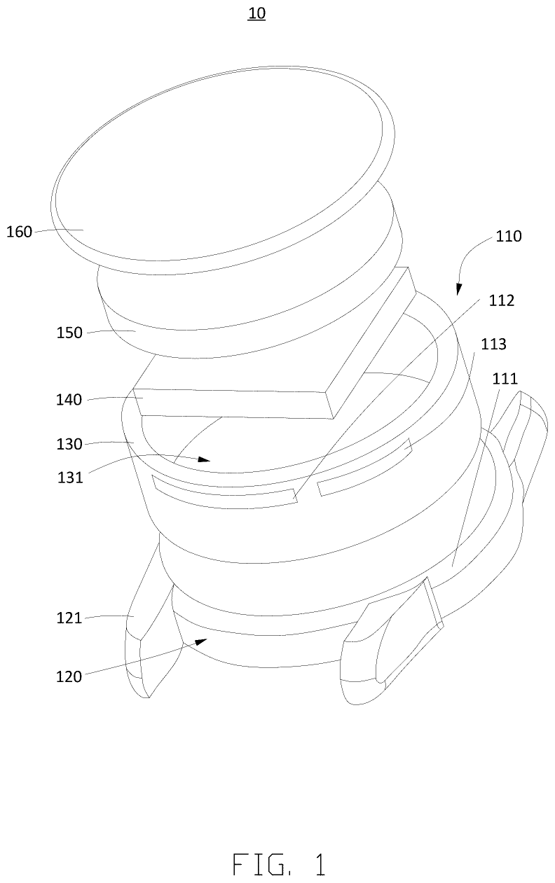

Referring to FIG. 1, an embodiment of the present application provides an antenna 110 applied in a wearable device 10. In some embodiments, the wearable device 10 is taken as a watch for example. In other embodiments, the wearable device 10 may also be other smart wearable devices such as a wristband, a bracelet, a ring, a smart helmet, etc. The present application does not limit the specific type of the wearable device 10. The wearable device 10 includes a metal ring 120, an insulating housing 130, a battery 140, a circuit board 150, and a cover 160.

In some embodiments, the metal ring 120 is substantially a cylinder with two connected ends. The metal ring 120 can serve as the outer housing of the wearable device 10. The wearable device 100 further includes connecting members 121 (in this embodiment, a watch ear is used as an example). The connecting members 121 are disposed outside the metal ring 120. Two connecting members 121 disposed on one side of the metal ring 120 are used to connect a belt (in this embodiment, a watch belt is used as an example) (not shown in the figures), and two other connecting members 121 disposed on the other side of the metal ring 120 are used to connect another belt. In other embodiments, other housings (not shown in the figures) formed of insulating materials may serve as the outer housing of the wearable device 10. The housing is also substantially a cylinder with two ends connected, and the position of the housing is the same as the position of the metal ring 120 in FIG. 1. At this time, the metal ring 120 may be a substantially annular sheet. Furthermore, the metal ring 120 may be disposed on an inner side of one end of a non-conductive housing. That is, the metal ring 120 referred to in the present application at least includes a ring-shaped sheet. In some embodiments, the metal ring 120 may be a whole body formed by integrally molding the watch ring and the housing. In other embodiments, the metal ring 120 may also be a circular sheet, which is not limited in the present application.

The insulating housing 130 is substantially a cylinder with one end open. A diameter of the insulating housing 130 is smaller than a diameter of the metal ring 120. The metal ring 120 is sleeved outside the insulating housing 130. Specifically, the metal ring 120 is disposed approximately in the middle outside the insulating housing 130. The insulating housing 130 has an open end to form a receiving space 131. The battery 140 and the circuit board 150 are stacked and disposed in the receiving space 131. The battery 140 is disposed close to a bottom of the insulating housing 130. The insulating housing 130 may be a plastic housing, a glass housing, a ceramic housing, etc., and the present application does not limit the specific material forming the insulating housing 130. In some embodiments, the insulating housing 130 may be a plastic housing.

The battery 140 is used to supply power to each power-consuming unit in the wearable device 100. In some embodiments, battery 140 may be a rechargeable battery.

The circuit board 150 may be, for example, a PCB board. The circuit board 150 is provided with a control circuit, a radio frequency circuit, a grounding point and other functional circuits (such as a display circuit, a health monitoring circuit, a motion monitoring circuit, etc.). The circuit board 150 is electrically connected to the battery 140 for receiving electrical energy provided by the battery 140 to maintain the normal function of the wearable device 10.

The cover 160 is disposed on a side of the circuit board 150 away from the battery 140. The cover 160 is engaged with or abuts against an inner wall of the insulating housing 130. Thus, the cover 160 and the insulating housing 130 can jointly form a closed space, the circuit board 150 and the battery 140 are arranged in the closed space, so that the wearable device 10 has a certain dustproof and waterproof function. In some embodiments, the cover 160 may be made of a transparent material, such as a transparent plastic or glass, so that the surface of the liquid crystal display module disposed on the circuit board 150 can be observed through the cover 160. In some other embodiments, the cover 160 may also be a liquid crystal display module (LCD module).

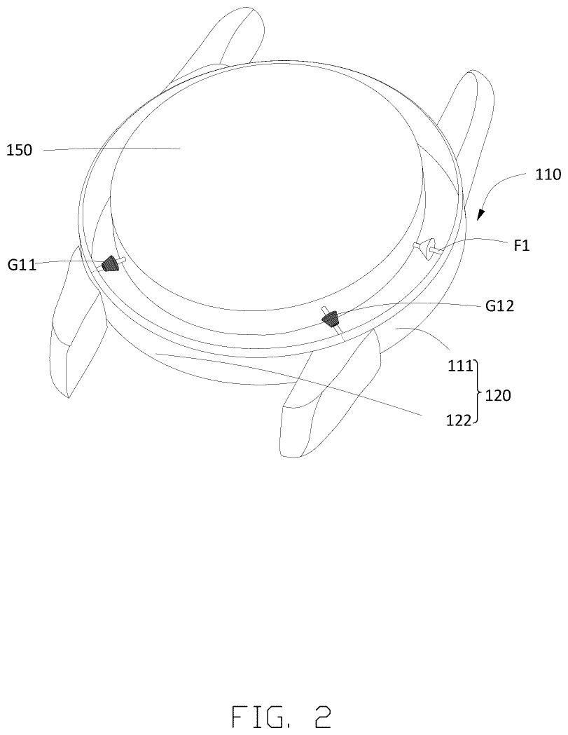

The antenna 110 includes a first radiating portion 111, a second radiating portion 112, and a third radiating portion 113. Referring to FIG. 2, the antenna 110 further includes a first feeding portion F1 and a grounding portion. The first feeding portion F1 provides a feeding current to the first radiating portion 111, so that the first radiating portion 111 excites a corresponding mode. The grounding portion is used to provide a grounding signal for the antenna 110. The detailed introduction of the grounding portion will be expanded below.

The first radiating portion 111 is formed by a portion of the metal ring 120. Furthermore, the metal ring 120 is grounded via the grounding portion. The first radiating portion 111 is connected to the first feeding portion F1 to receive the current fed by the first feeding portion F1, thereby exciting a first frequency band. A portion of the metal ring 120 forms a metal section 122, the metal section 122 and the first radiating portion 111 on the metal ring 120 do not overlap. For example, the metal section 122 may be formed on a portion of the metal ring 120 except the first radiating portion 111.

A first end of the first feeding portion F1 is connected to a feeding source (not shown in the figures) on the circuit board 150, and a second end of the first feeding portion F1 is connected to the metal ring 120. In one embodiment, specifically, the second end of the first feeding portion F1 is connected to a position on the metal ring 120 between two connecting members 121, and the two connecting members 121 are respectively used to connect corresponding strips. In other embodiments, the second end of the first feeding portion F1 may also be connected to other positions of the metal ring 120, and the present application does not impose any specific limitation on this.

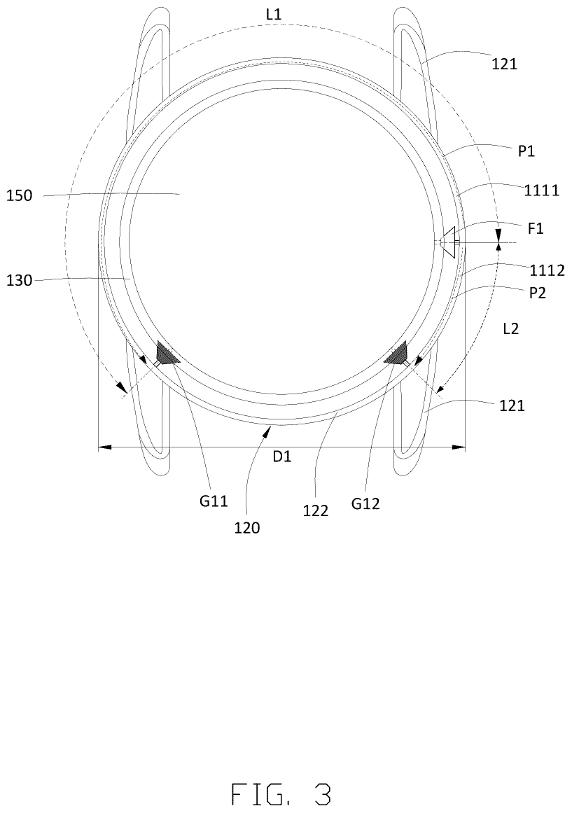

Referring to FIG. 3, in this embodiment, the grounding portion includes a first radiating section grounding portion G11 and a second radiating section grounding portion G12. The first ends of the first radiating section grounding portion G11 and the second radiating section grounding portion G12 are both connected to a ground point on the circuit board 150. Therefore, the first radiating portion 111 is divided into a first radiating section 1111 and a second radiating section 1112 by the first feeding portion F1, the first radiating section grounding portion G11 and the second radiating section grounding portion G12. The portion of the metal ring 120 between the first feeding portion F1 and the first radiating section grounding portion G11 forms the first radiation section 1111, and the portion of the metal ring 120 between the first feeding portion F1 and the second radiating section grounding portion G12 forms the second radiation section 1112. That is, the two ends of the first radiating portion 111 are connection points of the first radiating section grounding portion G11 and the metal ring 120 and connection points of the second radiating section grounding portion G12 connected to the metal ring 120; the two ends of the first radiating section 1111 are the connection points of the first radiating section grounding portion G11 and the metal ring 120 and the connection points of the first feeding portion F1 and the metal ring 120; the two ends of the second radiating section 1112 are the connection points of the second radiating section grounding portion G12 and the metal ring 120 and the connection points of the first feeding portion F1 and the metal ring 120.

Specifically, in this embodiment, a first end of the first radiating section grounding portion G11 is connected to the circuit board 150, and a second end of the first radiating section grounding portion G11 is connected to a position of the metal ring 120 corresponding to the connecting member 121 away from the first feeding portion F1. A first end of the second radiating section grounding portion G12 is connected to the circuit board 150, a second end of the second radiating section grounding portion G12 is connected to a position on the metal ring 120 corresponding to the connecting member 121 close to the first feeding portion F1. In one embodiment, the first radiating section grounding portion G11 and the second radiating section grounding portion G12 are respectively disposed corresponding to two connecting members 121, and the two connecting members 121 are located on the same side of the metal ring 120. That is, in one embodiment, the second radiating section grounding portion G12 is arranged closer to the first feeding portion F1 than the first radiating section grounding portion G11, and the second radiating section grounding portion G12 is arranged between the first radiating section grounding portion G11 and the first feeding portion F1 (especially in the relative position of the circumference, the circumference is, for example, the circumference formed by a range between the circuit board 150 and the metal ring 120). In one embodiment, the second radiating section grounding portion G12 is disposed closer to the first feeding portion F1 than the first radiating section grounding portion G11. In this embodiment, the position on the metal ring 120 connected to the first feeding part F1 is taken as a starting point, and the part of the metal ring 120 from the starting point along a first clock direction (for example, counterclockwise direction) of the metal ring 120 to the position on the metal ring 120 connected to the first radiating section grounding part G11 is used as the first radiation section 1111. The portion of the metal ring 120 from the starting point along a second clock direction (for example, clockwise direction) of the metal ring 120 to the position on the metal ring 120 connected to the second radiating section grounding portion G12 serves as the second radiation section 1112, the first clock direction and the second clock direction are opposite clock directions to each other. In other embodiments, the first radiating section grounding portion G11 and the second radiating section grounding portion G12 may also be connected to other positions of the metal ring 120, so as to form the first radiation section 1111 and the second radiation section 1112 with other lengths at other positions on the metal ring 120. The present application does not limit the specific positions where the first radiating section grounding portion G11 and the second radiating section grounding portion G12 are connected to the metal ring 120, nor does it limit the lengths of the first radiation section 1111 and the second radiation section 1112 or the length relationship between the two. More specifically, the lengths of the first radiation section 1111 and the second radiation section 1112 or the length relationship between the two can be adjusted according to the required radiation frequency band.

After the first feeding portion F1 feeds current, the current flows through the first radiation section 1111 and is grounded through the first radiating section grounding portion G11 to form a first current path P1. After the first feeding portion F1 feeds current, the current flows through the second radiation section 1112 and is grounded through the second radiating section grounding portion G12 to form a second current path P2.

In one embodiment, a diameter D1 of the metal ring 120 may be 43 mm (millimeter). A length L1 of the first radiation section 1111 may be 83 mm. A length L2 of the second radiation section 1112 may be 17 mm. In one embodiment, the length L1 of the first radiation section 1111 is greater than the length L2 of the second radiation segment 1112, so that the frequency of excitation of the first current path P1 on the first radiation section 1111 is lower than the frequency of excitation of the second current path P2 on the second radiation section 1112.

In this embodiment, the first frequency band includes Low Band (LB), Middle Band (MB) or High Band (HB) of LTE and 5G NR (New Radio) mode. The first current path P1 on the first radiation section 1111 excites the Low Band (LB) of LTE. The operating frequency bands of Low Band (LB) of LTE can cover LTE-A Band 17 (704-746 MHz), LTE-A Band 13 (746-787 MHz), LTE-ABand20 (791-862 MHz) and LTE-A Band 8 (880-960 MHz), etc. The second current path P2 on the second radiation section 1112 excites the Middle Band (MB) and High Band (HB) of LTE and the 5G NR modes. The operating frequency bands of Middle Band (MB) and High Band (HB) of LTE can cover 1710-2690 MHz, such as LTE Band 4 (1700-2100 MHZ), LTE Band 66 (1710-2200 MHz) and LTE Band 2 (1850-1990 MHz). The operating frequency band of 5G NR mode can cover 3300-5000 MHz.

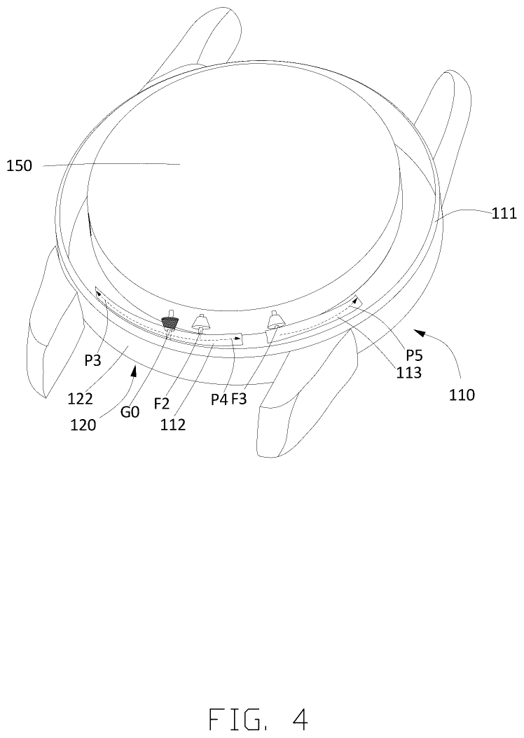

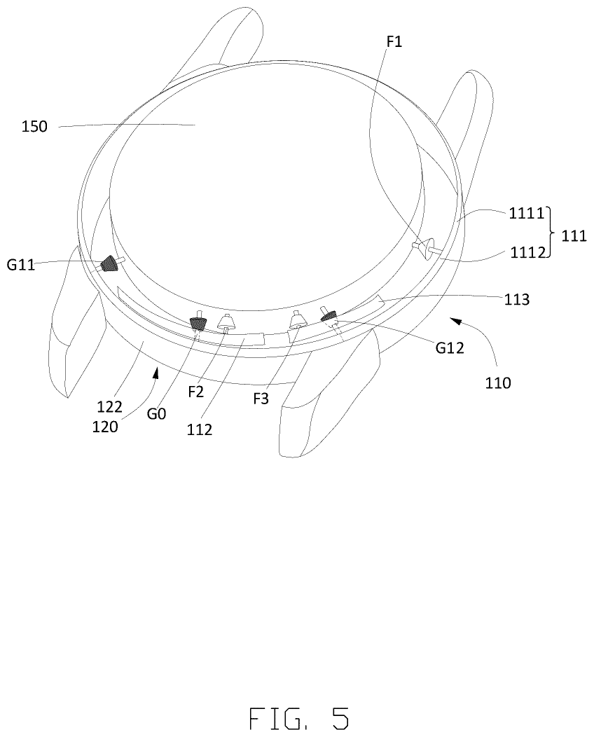

Referring to FIG. 4 (for the sake of simplicity, FIG. 4 does not show the insulating housing 130), the second radiating portion 112 and the first radiating portion 111 are arranged in a staggered manner. The second radiating portion 112 is connected to the second feeding portion F2 to receive the current fed by the second feeding portion F2, so as to excite a second frequency band. The third radiating portion 113 is connected to the third feeding portion F3 to receive the current fed by the third feeding portion F3, thereby exciting a third frequency band. Referring to FIG. 1 and FIG. 5, the second radiating portion 112 and the third radiating portion 113 are disposed on inside the first radiating portion 111, and the second radiating portion 112 and the third radiating portion 113 are disposed outside the insulating housing 130 (see FIG. 1). That is, the second radiating portion 112 and the third radiating portion 113 are disposed between the insulating housing 130 and the metal ring 120.

Referring to FIG. 1 and FIG. 5 (for simplicity, FIG. 5 does not show the insulating housing 130). Specifically, the second radiating portion 112 is disposed on a side of the insulating housing 130 close to the metal ring 120 where the first radiating portion 111 is not formed. In addition, the first end of the second radiating portion 112 is close to the connection point between the first radiating section grounding portion G11 and the metal ring 120, the second end of the second radiating portion 112 is close to the connection point between the second radiating section grounding portion G12 and the metal ring 120. In one embodiment, the first end of the second radiating portion 112 is located on a side of the first radiating section grounding portion G11 away from the first radiating section 1111, the second end of the second radiating portion 112 is located on a side of the second radiating section grounding portion G12 away from the second radiating section 1112. The third radiating portion 113 is spaced apart from the second radiating portion 112. The first end of the third radiating portion 113 is close to the second end of the second radiating portion 112. The second end of the third radiating portion 113 is close to the first feeding portion F1 and is spaced a certain distance from the first feeding portion F1. Thus, in this embodiment, the second radiating portion 112 is disposed corresponding to the metal section 122 on the metal ring 120, and a portion of the third radiating portion 113 is disposed corresponding to the second radiating section 1112.

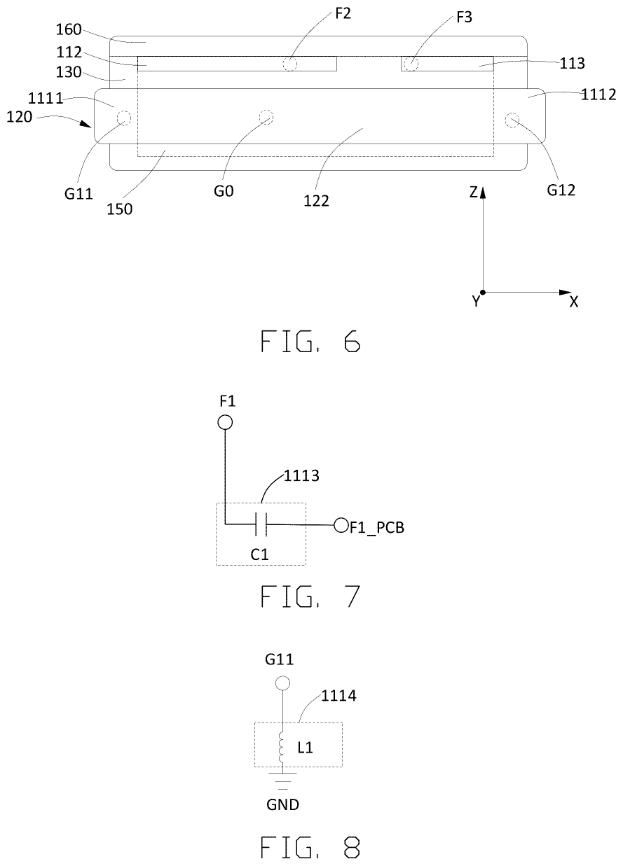

Referring to FIG. 5 and FIG. 6, the third radiating portion 113 is staggered with the first radiating portion 111 and the second radiating portion 112. In one embodiment, the first radiating portion 111 is arranged in a first circle with a center of the wearable device 10 as the center, the second radiating portion 112 and the third radiating portion 113 are arranged in a second circle with the center of the wearable device 10 as the center, the first circle and the second circle are concentric circles with different circumferences. The second radiating portion 112 and the third radiating portion 113 are both located on the outside of the insulating housing 130. Thus, the second radiating portion 112 and the third radiating portion 113 are located at different circumferences of the same circle. The first radiating portion 111 is located on the metal ring 120, and the distance between the first radiating portion 111 and the center of the first circle is greater than the distance between the second radiating portion 112 and the third radiating portion 113 and the center of the second circle. Thus, in one embodiment, the circle where the first radiating portion 111 is located is concentric with the circles where the second radiating portion 112 and the third radiating portion 113 are located; a radius of the circle where the first radiating portion 111 is located is greater than a radius of the circle where the second radiating portion 112 and the third radiating portion 113 are located. The circumference of the first radiating portion 111 partially overlaps with the circumference of the third radiating portion 113. In this way, the second radiating portion 112, the third radiating portion 113 and the first radiating portion 111 are staggeredly disposed at different circumferences. Referring to FIG. 6, in a coordinate system with the direction of the diameter D1 of the wearable device 10 (see FIG. 3) as the X-axis, the thickness direction of the wearable device 10 perpendicular to the diameter D1 as the Z-axis, and the direction perpendicular to the diameter D1 as the Y-axis, the first radiating portion 111, the second radiating portion 112 and the third radiating portion 113 are staggered on the X-Y plane. In addition, the first radiating portion 111 and the second radiating portion 112 and the third radiating portion 113 may be staggered in the height direction (Z-axis).

Referring to FIG. 6, in the Z-axis direction of the coordinate system, the second radiating portion 112 and the third radiating portion 113 are both disposed in a staggered manner with respect to the first radiating portion 111. Specifically, the heights of the second radiating portion 112 and the third radiating portion 113 in the Y-axis direction are higher than the height of the first radiating portion 111 in the Y-axis direction. In this way, the interference of the metal ring 120 on the second radiating portion 112 and the third radiating portion 113 can be reduced, thereby improving the radiation efficiency of the antenna 110. In one embodiment, the heights of the second feeding portion F2 and the third feeding portion F3 in the Y-axis direction are higher than the first radiating section grounding portion G11 and the second radiating section grounding portion G12.

Referring to FIG. 5, a first end of the second feeding portion F2 is connected to a corresponding feeding source on the circuit board 150, a second end of the second feeding portion F2 is connected to an end of the second radiating portion 112 close to the first feeding portion 111, i.e., a second end of the second radiating portion 112. A first end of the third feeding portion F3 is connected to a corresponding feeding source on the circuit board 150, a second end of the third feeding portion F3 is connected to an end of the third radiating portion 113 close to the second radiating portion 112, i.e., a first end of the third radiating portion 113. Furthermore, the position where the third radiating portion 113 is connected to the second end of the third feeding portion F3 is substantially located on a side of the second radiating section grounding portion G12 away from the second radiating section 1112 in a plan view.

Referring to FIG. 5, in the embodiment of the present application, the second radiating portion 112 and the third radiating portion 113 are both substantially in the shape of a curved sheet, and the second radiating portion 112 and the third radiating portion 113 can be a flexible printed circuit (FPC) or formed by a laser direct structuring (LDS) process. In some embodiments, the second radiating portion 112 and the third radiating portion 113 may be disposed on the outside of the insulating housing 130 by adhesive (see FIG. 1).

In other embodiments, the shapes of the second radiating portion 112 and the third radiating portion 113 may also be adjusted according to different internal environments of the wearable device 10. The present application does not strictly limit the specific shapes, lengths, and locations of the second radiating portion 112 and the third radiating portion 113.

Referring to FIG. 4 and FIG. 5, in the present application, the grounding portion further includes a decoupling grounding portion G0. A first end of the decoupling grounding portion G0 is connected to a grounding point on the circuit board 150, a second end of the decoupling grounding portion G0 is connected to a position on the metal ring 120 corresponding to the second radiating portion 112. In one embodiment, the second end of the decoupling grounding portion G0 is connected to a position on the metal ring 120, for example, located at a side of the second feeding portion F2 away from the second radiating section grounding portion G12. After the first feeding portion F1 feeds in current, the current enters the metal ring 120 (especially the first radiating portion 111) from the first feeding portion F1, and the current is respectively guided to the ground from the first radiating section grounding portion G11 and the second radiating section grounding portion G12. Therefore, the current fed in from the first feeding portion F1 will only flow through the metal ring 120 forming the first radiating portion 111, that is, the current fed in by the first feeding portion F1 will not flow through the metal section 122 of the metal ring 120, the metal section 122 and the first radiating portion 111 do not overlap on the metal ring 120. However, since the second radiating portion 112 is adjacent to the metal section 122 on the metal ring 120, the metal section 122 on the metal ring 120 may be coupled with the second radiating portion 112, thereby affecting the radiation gain of the second radiating portion 112. Therefore, in the present application, the decoupling grounding portion G0 is connected at a position on the metal section 122 of the metal ring 120 corresponding to the second radiating portion 112 to avoid coupling between the second radiating portion 112 and the metal section 122 on the metal ring 120 close to the second radiating portion 112, thereby improving the radiation gain of the second radiating portion 112. Referring to FIG. 6, in one embodiment, the heights of the second feeding portion F2 and the third feeding portion F3 in the Y-axis direction are higher than the decoupling grounding portion G0. In this embodiment, the first radiating section grounding portion G11, the second radiating section grounding portion G12, and the decoupling grounding portion G0 are not connected to the second radiating portion 112 and the third radiating portion 113.

Referring to FIG. 4, after the second feeding portion F2 feeds current, the current flows toward the second radiating portion 112 to form a third current path P3. After the second feeding portion F2 feeds the current, the current also flows to the second end of the second radiating portion 112 to form a fourth current path P4. After the third feeding portion F3 feeds current, the current flows through the third radiating portion 113 to form a fifth current path P5.

In the present application, the second frequency bands stimulated by the third current path P3 and the fourth current path P4 of the second radiating portion 112 include GPS band, 2.4 GHZ WIFI band and Bluetooth band. Specifically, the third current path P3 may excite the GPS mode, and the operating frequency band of the GPS band may include 1550-1612 MHz. The fourth current path P4 can stimulate the 2.4 GHZ WIFI band and the Bluetooth band, and the operating frequency bands of the 2.4 GHz WIFI band and the Bluetooth band may include 2400-2500 MHz. The third frequency band excited by the fifth current path P5 of the third radiating portion 113 includes the 5 GHZ WIFI band. Specifically, the operating frequency band of the 5 GHZ WIFI band may include 5150-5850 MHz.

The antenna 110 provided in the present application feeds current to the metal ring 120 via the first feeding portion F1, so that the portion of the metal ring 120 forms the first radiating portion 111 to excite the first frequency band, thereby reducing the space occupied by the antenna 110 in the wearable device 10. The antenna 110 further broadens the bandwidth of the antenna 110 by disposing the second radiating portion 112 and the third radiating portion 113, and excites the second frequency band and the third frequency band respectively. In this way, the antenna 110 provided in the present application can provide a wider operating frequency band within the limited space of the wearable device 10 and has better antenna performance.

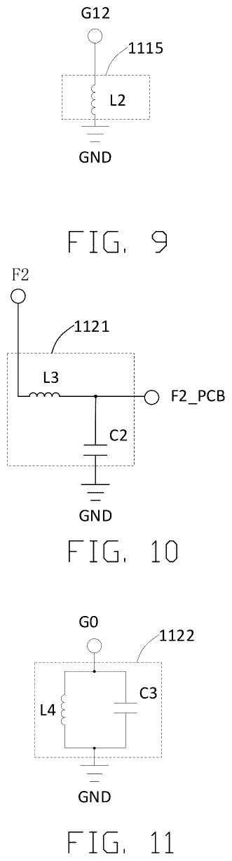

Referring to FIG. 7 to FIG. 9, the antenna 110 further includes a first matching circuit 1113, a first tuning circuit 1114, and a second tuning circuit 1115.

The first end of the first feeding portion F1 is connected to a first feeding source F1_PCB via the first matching circuit 1113. In some embodiments, the first matching circuit 1113 includes a first capacitor C1. One end of the first capacitor C1 is connected to the first end of the first feeding portion F1, and the other end of the first capacitor C1 is connected to the first feeding source F1_PCB.

The first radiating section grounding portion G11 is grounded via the first tuning circuit 1114. In some embodiments, the first tuning circuit 1114 includes a first inductor L1. One end of the first inductor L1 is connected to a first end of the first radiating section grounding portion G11, and the other end of the first inductor L1 is grounded. The working frequency band of the first radiating section 1111 can be adjusted more accurately through the first tuning circuit 1114. FIG. 7 only exemplary shows that the first tuning circuit 1114 includes the first inductor L1, but in other embodiments, the first tuning circuit 1114 may include inductor(s) and/or capacitor(s) to adjust the operating frequency band of the first radiating section 1111.

The second radiating section grounding portion G12 is grounded via the second tuning circuit 1115. In some embodiments, the second tuning circuit 1115 includes a second inductor L2. One end of the second inductor L2 is connected to the first end of the second radiating section grounding portion G12, and the other end of the second inductor L2 is grounded. The working frequency band of the second radiating section 1112 can be adjusted more accurately through the second tuning circuit 1115. FIG. 8 only exemplarily shows that the second tuning circuit 1115 includes the second inductor L2, but in other embodiments, the second tuning circuit 1115 may include inductor(s) and/or capacitor(s) to adjust the operating frequency band of the second radiating section 1112.

Referring to FIG. 10 and FIG. 11, the antenna 110 further includes a second matching circuit 1121 and a third tuning circuit 1122.

The second feeding portion F2 is connected to a second feeding source F2_PCB via the second matching circuit 1121. In some embodiments, the second matching circuit 1121 includes a third inductor L3 and a second capacitor C2. One end of the third inductor L3 is connected to the first end of the second feeding portion F2, and the other end of the third inductor L3 is connected to the second feeding source F2_PCB. One end of the second capacitor C2 is connected between the third inductor L3 and the second feeding source F2_PCB, and the other end of the second capacitor C2 is grounded.

The decoupling grounding portion G0 is grounded via the third tuning circuit 1122. In some embodiments, the third tuning circuit 1122 includes a fourth inductor L4 and a third capacitor C3. First ends of the fourth inductor L4 and the third capacitor C3 are both connected to the first end of the decoupling ground portion G0. Second ends of the fourth inductor L4 and the third capacitor C3 are both grounded. Through the third tuning circuit 1122, the radiation efficiency of the second radiating portion 112 in the GPS frequency band and the Wi-Fi 2.4 G/BT frequency band can be adjusted more accurately. FIG. 11 only exemplary shows that the third tuning circuit 1122 includes the fourth inductor L4 and the third capacitor C3, but in other embodiments, the third tuning circuit 1122 may include inductor(s) and/or capacitor(s) to adjust the radiation efficiency of the second radiating portion 112 in the GPS frequency band and the Wi-Fi 2.4 G/BT frequency band.

Referring to FIG. 12, the antenna 110 further includes a third matching circuit 1131. The third feeding portion F3 is connected to a third feeding source F3_PCB via the third matching circuit 1131. In some embodiments, the third matching circuit 1131 includes a fourth capacitor C4. One end of the fourth capacitor C4 is connected to the first end of the third feeding portion F3, and the other end of the fourth capacitor C4 is connected to the third feeding source F3_PCB.

The first matching circuit 1113, the second matching circuit 1115, and the third matching circuit 1131 may be used to adjust the impedance matching of the corresponding first radiating portion 111, the second radiating portion 112, and the third radiating portion 113. The first tuning circuit 1114, the second tuning circuit 1115, and the third tuning circuit 1122 are used to adjust the resonant frequencies of the first radiating portion 111 and the second radiating portion 112. Although not shown in FIGS. 1 to 5, the first feeding source F1_PCB, the second feeding source F2_PCB, and the third feeding source F3_PCB mentioned above may all be located on the circuit board 150.

The present application does not limit the circuit structures of the first matching circuit 1113, the first tuning circuit 1114, the second tuning circuit 1115, the second matching circuit 1121, the third tuning circuit 1122 and the third matching circuit 1131. In other embodiments, the above-mentioned circuits may also adjust the types of electronic components and parameters of electronic components therein according to the actual parameters of the wearable device 10.

The first feeding portion F1, the second feeding portion F2, the third feeding portion F3, the first radiating section grounding portion G11, the second radiating section grounding portion G12 and the decoupling grounding portion G0 mentioned in the present application can be connecting structures such as spring clips, screws, microstrip lines, probes, or other conductive metal portions. In some embodiments, the first feeding portion F1, the second feeding portion F2, the third feeding portion F3, the first radiating section grounding portion G11, the second radiating section grounding portion G12 and the decoupling grounding part G0 may be the same structure. In other embodiments, the first feeding portion F1, the second feeding portion F2, the third feeding portion F3, the first radiating section grounding portion G11, the second radiating section grounding portion G12 and the decoupling grounding part G0 may also be different structures, and the present application is not limited to this.

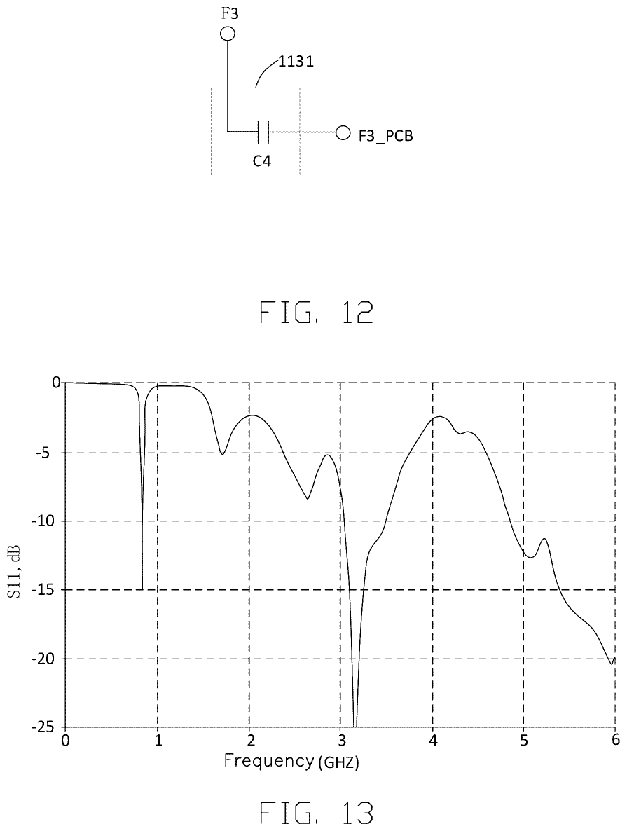

Referring to FIG. 13, which is a graph diagram of an S parameter (scattering parameter) curve of the first radiating portion 111 in an embodiment of the present application. Obviously, it can be seen from FIG. 13 that the first radiating portion 111 covers the operating frequency bands of Low Band (LB), Middle Band (MB) and High Band (HB) of LTE (such as 700-900 MHz and 1710-2690 MHz, etc.) and the operating frequency bands of 5G NR modes (such as 3300-5000 MHz), which meets the antenna design requirements.

Referring to the following Table 1, which shows the radiation efficiency values of the first radiating portion 111 measured in the Low Band (LB) of LTE (Low Band, LB), Middle Band (MB) of LTE (Middle Band, MB), High Band (HB) of LTE (High Band, HB) and 5G NR band. It can be seen from Table 1 that the first radiating portion 111 has better radiation efficiency and meets the antenna design requirements of LTE low, middle and high frequencies and 5G NR.

TABLE 1
Antenna radiation efficiency of the first radiating portion

| Frequency | | Antenna efficiency |
|---|---|---|
| (MHz) | | (dB) |
| LB | 824 | −16.4 |
| | 859 | −16.0 |
| | 894 | −19.3 |
| MB | 1710 | −3.4 |
| | 1795 | −3.6 |
| | 1850 | −4.0 |
| | 1920 | −4.5 |
| | 2200 | −4.2 |
| HB | 2300 | −3.5 |
| | 2400 | −3.1 |
| | 2500 | −3.0 |
| | 2600 | −2.2 |
| | 2700 | −2.0 |
| NR | 3300 | −1.1 |
| | 3750 | −2.5 |
| | 4200 | −4.4 |
| | 4400 | −3.3 |
| | 4700 | −2.4 |
| | 5000 | −1.4 |

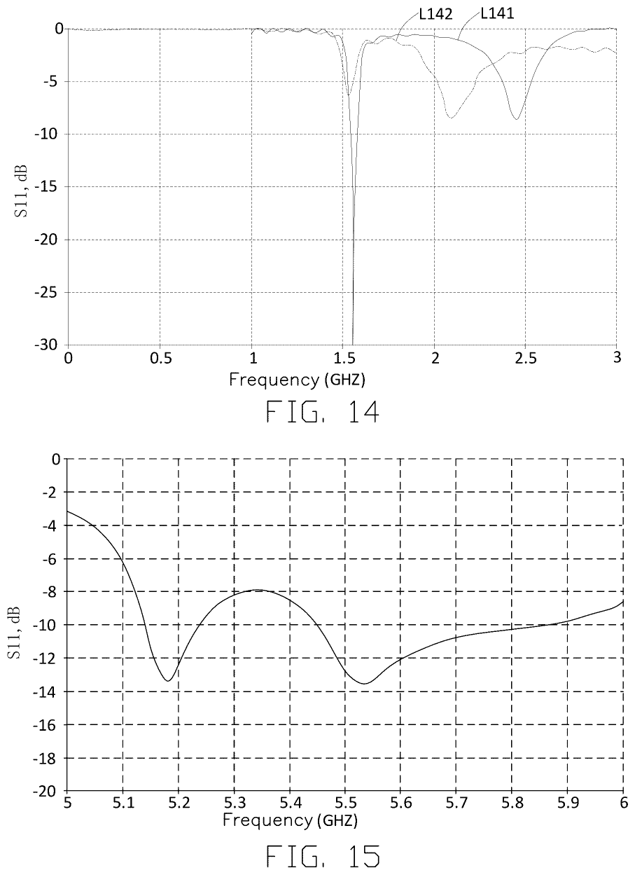

Referring to FIG. 14, which is a graph diagram of an S parameter (scattering parameter) curve of the second radiating portion 112 in an embodiment of the present application. Curve L141 is the S11 curve of the second radiating portion 112 measured after the decoupling grounding portion G0 is provided in the embodiment of the present application. Curve L142 is the S11 curve of the second radiating portion 112 measured when the decoupling grounding portion G0 is not provided. Obviously, by disposing the decoupling grounding portion G0, the return loss of the second radiating portion 112 can be reduced.

Referring to the following Table 2, which shows the radiation efficiency values of the second radiating portion 112 measured in the GPS frequency band and the Wi-Fi 2.4 G/BT (Bluetooth) frequency band. It can be seen from Table 2 that by providing the decoupling grounding portion G0, the second radiating portion 112 has better radiation efficiency in the GPS band and the Wi-Fi 2.4 G/BT band, meeting the antenna design requirements of the GPS band and the Wi-Fi 2.4 G/BT band.

TABLE 2
Antenna radiation efficiency of the second radiating portion

| | | Antenna efficiency of | Antenna efficiency of without |
|---|---|---|---|
| Frequency | | with the decoupling | the decoupling grounding G0 |
| (MHz) | | grounding G0 (dB) | (dB) |
| GPS | 1550 | −3.6 | −9.5 |
| | 1575 | −3.2 | −9.1 |
| | 1600 | −4.2 | −9.2 |
| Wi-Fi | 2400 | −3.4 | −6.4 |
| 2.4 G/ | 2450 | −3.2 | −7.1 |
| BT | 2500 | −3.8 | −7.6 |

Referring to FIG. 15, which is a graph diagram of an S parameter (scattering parameter) of the third radiating portion 113 according to an embodiment of the present application. Obviously, it can be seen from FIG. 15 that the third radiating portion 113 covers the operating frequency band of the Wi-Fi 5G mode (for example, 5150-5850 MHZ, etc.), which meets the antenna design requirements.

Referring to the following Table 3, which shows the radiation efficiency values of the third radiation portion 113 measured in the Wi-Fi 5G frequency band. It can be seen from Table 3 that the third radiating portion 113 has better radiation efficiency in the Wi-Fi 5G frequency band and meets the antenna design requirements of the Wi-Fi 5G frequency band.

TABLE 3
Antenna radiation efficiency of the second radiating portion

| Frequency | | Antenna efficiency |
|---|---|---|
| (MHz) | | (dB) |
| Wi-Fi | 5150 | −1.8 |
| 5 G | 5500 | −4.0 |
| | 5850 | −3.5 |

Referring to FIG. 16, which is a graph diagram of an S parameters (scattering parameters) of the first radiating portion 111 operating in the LB, MB, and HB of LTE and the second radiating portion 112 operating in the GPS frequency band, provided in an embodiment of the present application. Curve L161 is the S11 curve of the first radiating portion 111 working in the LB, MB, and HB of LTE. Curve L162 is the S11 curve when the second radiating portion 112 operates in the GPS frequency band. Curve L163 is an isolation curve between the first radiating portion 111 and the second radiating portion 112. Obviously, it can be seen from FIG. 16 that since the first radiating portion 111 and the second radiating portion 112 are staggered, there is a better isolation between the first radiating portion 111 and the second radiating portion 112. In this way, the antenna 110 and the wearable device 10 having the antenna 110 can work in the LB, MB, and HB of LTE and the GPS band at the same time, which is conducive to using the A-GPS (Assisted GPS) fast positioning technology to quickly complete positioning through mobile communication base station information and GPS information.

Referring to FIG. 1, the present application also provides a wearable device 10. The wearable device 10 includes the metal ring 120. The wearable device 10 includes the first feeding portion F1, the second feeding portion F2, the third feeding portion F3, the first radiating portion 111, the second radiating portion 112, the third radiating portion 113 and the grounding portion.

The first radiating portion 111 is formed by a portion of the metal ring 120. The first radiating portion 111 is connected to the first feeding portion F1 to receive the current fed by the first feeding portion F1, thereby exciting the first frequency band. The second radiating portion 112 and the first radiating portion 111 are arranged in a staggered manner. The second radiating portion 112 is connected to the second feeding portion F2 to receive the current fed by the second feeding portion F2, so as to excite the second frequency band. The third radiating portion 113 is staggered with the first radiating portion 111 and the second radiating portion 112. The third radiating portion 113 is connected to the third feeding portion F3 to receive the current fed by the third feeding portion F3, thereby exciting the third frequency band. The metal ring 120 is grounded via the grounding portion.

For more details about the wearable device 10, please refer to the relevant description above, which will not be repeated here.

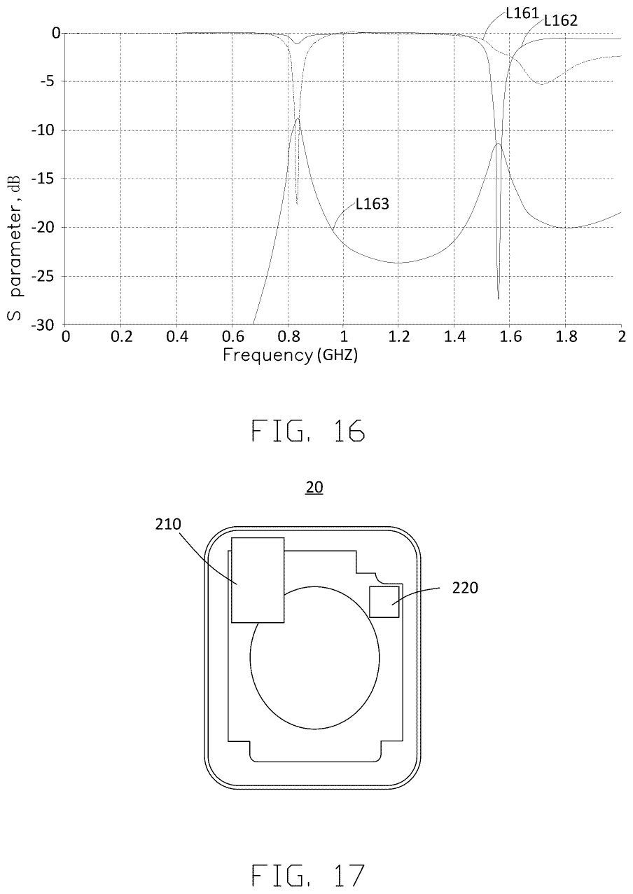

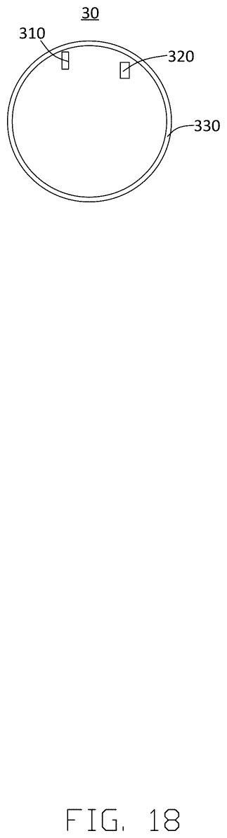

Referring to FIG. 17 and FIG. 18, FIG. 17 is a schematic diagram of a wearable device 20 in the prior art. The wearable device 20 is provided with a first patch antenna 210 and a second patch antenna 220. FIG. 18 is a schematic diagram of another wearable device 30 in the prior art. The wearable device 30 is provided with a first patch antenna 310, a second patch antenna 320 and a metal ring antenna 330. Referring to Table 4, which is a comparison table of the antenna performance of the antenna 110 in the wearable device 10 provided in the present application and the wearable devices 20 and 30 in the prior art.

TABLE 4
Comparison table of antenna performance between the wearable
device 10 and wearable devices in the prior art

| Frequency | | | | | |
|---|---|---|---|---|---|
| (MHz) | | wearable device 10 | | wearable device 20 | wearable device 30 |
| LTE | LB | First radiating portion 111 | | First patch antenna 210 | Metal ring antenna 330 |
| | MHB | | | Second patch antenna 220 | |
| NR | | | | NA. | NA. |
| GPS | | Second radiating portion | | Second patch antenna 220 | Metal ring antenna 330 |
| Wi-Fi 2.4 G | | 112 | | | First patch antenna 310/ |
| Wi-Fi 5 G | | Third radiating portion | | | second patch antenna 320 |
| | | 113 | | | |
| | | Antenna gain (dBi) | | | |
| LTE | LB | b13 | −11.8 | −29 | −13.5 |
| | MHB | b4/66 | 0.0 | −12.6 | −10.9 |
| | | b2 | 2.3 | −10.9 | −10.2 |

| NR | N77/78 | −0.7 | NA. |
|---|---|---|---|
| | N79 | 1.5 | |

| | | | |
|---|---|---|---|
| Isolation (dB) | LTE vs. GPS | -9 dB | 0 dB |

It can be seen from Table 4 that the antenna 110 provided in the present application can stimulate the 5G NR mode compared with the wearable device of the prior art. When the first radiating portion 111 excites the LB, MB, and HB of LTE and the second radiating portion 112 excites the GPS mode, there is good isolation between the first radiating portion 111 and the second radiating portion 112, so that the wearable device 10 can be positioned conveniently by using the A-GPS fast positioning technology. Moreover, when the wearable device 10 provided in the present application operates in the LB, MB, and HB of LTE, it has an antenna gain improvement of nearly 12 dBi compared to the wearable device 20. When the wearable device 10 provided in the present application operates in the LB of LTE, the antenna gain is increased by nearly 1.7 dBi compared to the wearable device 30; when operating in the MB of LTE, the antenna gain is increased by nearly 11 dBi compared to the wearable device 30; when operating in the HB of LTE, the antenna gain is increased by nearly 12.5 dBi compared to the wearable device 30. Obviously, the wearable device 10 provided in the present application has better antenna performance.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An antenna applied in a wearable device, the wearable device comprising a metal ring, the antenna comprising:
a first feeding portion, a second feeding portion, and a third feeding portion;
a first radiating portion formed by a portion of the metal ring, the first radiating portion connected to the first feeding portion to receive a current fed by the first feeding portion to excite a first frequency band;
a second radiating portion staggered with the first radiating portion, the second radiating portion connected to the second feeding portion to receive a current fed by the second feeding portion to excite a second frequency band;
a third radiating portion staggered with the first radiating portion and the second radiating portion, the third radiating portion connected to the third feeding portion to receive a current fed by the third feeding portion to excite a third frequency band; and
a grounding portion providing grounding to the metal ring;
wherein the second radiating portion and the third radiating portion are disposed inside the first radiating portion.

2. The antenna of claim 1, wherein the wearable device further comprises an insulating housing, the metal ring is sleeved outside the insulating housing, the second radiation portion and the third radiation portion are arranged between the insulating housing and the metal ring.

3. The antenna of claim 1, wherein the first frequency band comprises Low Band (LB), Middle Band (MB) or High Band (HB) of LTE.

4. The antenna of claim 1, wherein the second frequency band comprises a GPS band or a 2.4 GHz WIFI band.

5. The antenna of claim 1, wherein the third frequency band comprises a 5 GHZ WIFI band.

6. The antenna of claim 1, wherein the grounding portion comprises a first radiating section grounding portion and a second radiating section grounding portion, first ends of the first radiating section grounding portion and the second radiating section grounding portion are both connected to a ground point of the wearable device.

7. The antenna of claim 6, wherein the first radiating portion is divided into a first radiating section and a second radiating section by the first feeding portion, the first radiating section grounding portion and the second radiating section grounding portion, a portion of the metal ring between the first feeding portion and the first radiating section grounding portion forms the first radiation section, and a portion of the metal ring between the first feeding portion and the second radiating section grounding portion forms the second radiation section.

8. The antenna of claim 7, wherein a first end of the second radiating portion is close to a connection point between the first radiating section grounding portion and the metal ring, a second end of the second radiating portion is close to a connection point between the second radiating section grounding portion and the metal ring.

9. The antenna of claim 8, wherein the third radiating portion is spaced apart from the second radiating portion, a first end of the third radiating portion is close to the second end of the second radiating portion, a second end of the third radiating portion is close to the first feeding portion and is spaced a distance from the first feeding portion.

10. The antenna of claim 1, wherein the first radiating portion is arranged in a first circle with a center of the wearable device as the center, the second radiating portion and the third radiating portion are arranged in a second circle with the center of the wearable device as the center, the first circle and the second circle are concentric circles with different circumferences.

11. A wearable device comprising:
a metal ring;
an antenna comprising:
a first feeding portion, a second feeding portion, and a third feeding portion;
a first radiating portion formed by a portion of the metal ring, the first radiating portion connected to the first feeding portion to receive a current fed by the first feeding portion to excite a first frequency band;
a second radiating portion staggered with the first radiating portion, the second radiating portion connected to the second feeding portion to receive a current fed by the second feeding portion to excite a second frequency band;
a third radiating portion staggered with the first radiating portion and the second radiating portion, the third radiating portion connected to the third feeding portion to receive a current fed by the third feeding portion to excite a third frequency band; and
a grounding portion providing grounding to the metal ring;
wherein the second radiating portion and the third radiating portion are disposed inside the first radiating portion.

12. The wearable device of claim 11, further comprising an insulating housing, wherein the metal ring is sleeved outside the insulating housing, the second radiation portion and the third radiation portion are arranged between the insulating housing and the metal ring.

13. The wearable device of claim 11, wherein the first frequency band comprises Low Band (LB), Middle Band (MB) or High Band (HB) of LTE.

14. The wearable device of claim 11, wherein the second frequency band comprises a GPS band or a 2.4 GHZ WIFI band.

15. The wearable device of claim 11, wherein the third frequency band comprises a 5 GHZ WIFI band.

16. The wearable device of claim 11, further comprising a circuit board, wherein the grounding portion comprises a first radiating section grounding portion and a second radiating section grounding portion, first ends of the first radiating section grounding portion and the second radiating section grounding portion are both connected to a ground point of the circuit board.

17. The wearable device of claim 16, wherein the first radiating portion is divided into a first radiating section and a second radiating section by the first feeding portion, the first radiating section grounding portion and the second radiating section grounding portion, a portion of the metal ring between the first feeding portion and the first radiating section grounding portion forms the first radiation section, and a portion of the metal ring between the first feeding portion and the second radiating section grounding portion forms the second radiation section.

18. The wearable device of claim 17, wherein a first end of the second radiating portion is close to a connection point between the first radiating section grounding portion and the metal ring, a second end of the second radiating portion is close to a connection point between the second radiating section grounding portion and the metal ring.

19. The wearable device of claim 18, wherein the third radiating portion is spaced apart from the second radiating portion, a first end of the third radiating portion is close to the second end of the second radiating portion, a second end of the third radiating portion is close to the first feeding portion and is spaced a distance from the first feeding portion.

20. The wearable device of claim 11, wherein the first radiating portion is arranged in a first circle with a center of the wearable device as the center, the second radiating portion and the third radiating portion are arranged in a second circle with the center of the wearable device as the center, the first circle and the second circle are concentric circles with different circumferences.
